(19) United States
(12) Patent Application Publication
(10) Pub. No.: US 2008/0064389 A1
(43) Pub. Date: Mar. 13, 2008

(54) COMMUNICATION SYSTEM AND METHOD FOR REDIRECTING A CALL BETWEEN MULTIPLE DIFFERENT OPERATING MODES

(75) Inventor: APOSTOLIS K. SALKINTZIS, ATHENS (GR)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/531,606

(22) Filed: Sep. 13, 2006

(51) Int. Cl. H04Q 7/20

(52) U.S. Cl. 455/425

(57) ABSTRACT

The present invention provides a communication system and a method for redirecting a call to a call destination between multiple different operating modes. An attempt to establish a communication connection with the call destination is made via a first operating mode. Upon receipt of a rejection of the attempt to establish a communication connection, a determination is made as to a second operating mode, which is different from the first operating mode, that is capable of supporting a communication with the call destination via a communication connection. A type of call data for the call is then converted from a type corresponding to the first operating mode to a type corresponding to the second operating mode, and the call data of the call having the converted type corresponding to the second operating mode is communicated using a communication connection established with the call destination via the second operating mode.

### FIELD OF THE INVENTION

The present invention relates generally to the redirection of a call to a call destination between multiple different operating modes, and more particularly, to the conversion of the type of call data for the call from a type of call data corresponding to a first operating mode and a type of call data supporting a second operating mode as part of the redirection of the call.

### BACKGROUND OF THE INVENTION

Mobile communication devices have offered subscribers expanded opportunities for communicating with other users or devices over a distance, including increased convenience given the more portable nature of some communication devices, such as a cellular radio telephone, and an increase in the number of ways a communication can be received. For example, in addition to more traditional circuit switched voice calls, some devices support the receipt of other types of calls including text messages, voice messages and/or data messages, via the same or alternative operating modes, such as via a packet data network. In some instances, the greater opportunities to communicate through enhanced accessibility can extend to times when it is inappropriate or inconvenient to receive some types of calls. In some instances, a device may already be engaged in a call, and may not be capable of simultaneously supporting multiple calls of a particular type or via a particular mode, but may be currently capable of receiving the call via an alternative mode. However, the call originator may not always be aware of the circumstances, which impact the call destination's ability to appropriately and/or conveniently receive a call.

In many instances, the call may go unanswered with no indication as to why the call could not be received. In some of these instances, a generic indication concerning the inability to complete a call may be provided, and the caller may be prompted to leave a message, which can be stored for later retrieval. For communications that are not urgent or do not require a more immediate response, leaving a message for later retrieval may be sufficient. However in some instances, it might have been possible for the call destination to more immediately receive a communication allowing the user to act there upon, if an alternative manner of communication had been selected, and/or the alternative manner of communication was supported by the device through which the call was originated, either directly or indirectly. For such a communication via an alternative manner of communication to occur, the alternative manner of communication needs to be supported by one or both of the devices involved in the communication and/or some mechanism needs to be available for alternatively routing the call and for converting, where necessary, the call data in the one or more devices which does not support the alternative manner of communication.

As a result, it would be beneficial to develop a system or manner in which a call could be appropriately redirected to a call destination between multiple different operating modes, which allows for the alternative routing of the call via communication connections associated with an available one of multiple different operating modes and the corresponding conversion of the type of the call data.

### SUMMARY OF THE INVENTION

The present invention provides a method for redirecting a call to a call destination between multiple different operating modes. The method includes attempting to establish a communication connection with the call destination via a first operating mode. Upon receipt of a rejection of the attempt to establish a communication connection, the method further includes determining a second operating mode, which is different from the first operating mode, that currently is capable of supporting a communication with the call destination via a communication connection. A type of call data for the call is then converted from a type corresponding to the first operating mode to a type corresponding to the second operating mode, and the call data of the call having the converted type corresponding to the second operating mode is communicated using a communication connection established with the call destination via the second operating mode.

In at least one embodiment, the received rejection includes a redirection request. In some of those instances the redirection request includes an identification of the suggested second operating mode and a particular type corresponding to the second operating mode from one or more possible types. In other instances the redirection request causes the call to be routed to an application server, that forms at least part of a network infrastructure, where the application server manages the alternative routing of the call via the second operating mode.

In at least a further embodiment, the communication connection established with the call destination via the second operating mode occurs between a network infrastructure and the call destination, and the call type conversion occurs in the network infrastructure.

In a still further embodiment, the communication connection established with the call destination via the second operating mode occurs between a call originator and the call destination, and the call type conversion occurs in the call originator.

The present invention further provides a communication system. The communication system includes a plurality of communication devices including a call originator and a call destination, where at least the call destination includes a transceiver module for selectively establishing a communication connection via a first operating mode and a second operating mode. The communication system further includes a base transceiver station, which is adapted to selectively communicate with one or more of the plurality of communication devices via a first operating mode and a second operating mode. The communication system still further includes a network controller and an application server. The network controller is coupled to the base transceiver station, and includes a first mode call establishing module for establishing a communication connection for a call from the call originator to the call destination via the first operating mode, and a call redirecting module for redirecting the call upon receipt of a rejection of an attempt to establish a communication connection via the first operating mode. The application server is coupled to the base transceiver station and the network controller, and includes a call type conversion module for converting the type of a call redirected to the application server for communication via the second operating mode, and a second mode call establishing module for establishing a communication connection for a call from the call originator to the call destination via the second operating mode.

The present invention still further provides a further communication system. The further communication system includes a plurality of communication devices including a call originator and a call destination, where at least the call destination includes a transceiver module for selectively establishing a communication connection via a first operating mode and a second operating mode. The further communication system additionally includes a base transceiver station, which is adapted to selectively communicate with one or more of the plurality of communication devices via a first operating mode and a second operating mode. The further communication system also includes a network controller, which is coupled to the base transceiver station, and includes a first mode call establishing module for establishing a communication connection for a call from the call originator to the call destination via the first operating mode and providing feedback regarding whether the communication connection could be successfully established. The call originator includes a first mode call initiator module for initiating a communication connection for a call from the call originator to the call destination via the first operating mode, a call redirecting module for redirecting the call via a second operating mode upon receipt of a rejection of an attempt to establish a communication connection via the first operating mode, a call type conversion module for converting the type of a call which could not be established via the first operating mode from a first operating mode type to a second operating mode type, and a second mode call initiator module for initiating a communication connection for a call from the call originator to the call destination via the second operating mode.

These and other objects, features, and advantages of this invention are evident from the following description of one or more preferred embodiments of this invention, with reference to the accompanying drawings.

### BRIEF DESCRIPTION OF THE DRAWINGS

FIG. 1 is an exemplary topographical view of a geographical region representing a portion of the coverage area for a wireless communication system;

FIG. 2 is a block diagram of a communication system in accordance with at least one embodiment of the present invention;

FIG. 3 is a more detailed block diagram of a communication system, in accordance with at least one embodiment of the present invention;

FIG. 4 is a more detailed block diagram of a communication system, in accordance with at least a further embodiment of the present invention;

FIG. 5 is a block diagram illustrating at least one embodiment of the present invention, in conjunction with a pair of exemplary networks, namely a packet data network and a circuit switched network;

FIG. 6 is a block diagram of least one embodiment of the wireless communication device, which could be used to incorporate the present invention; and

FIG. 7 is a flow diagram of a method for redirecting a call to a call destination between multiple different operating modes, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

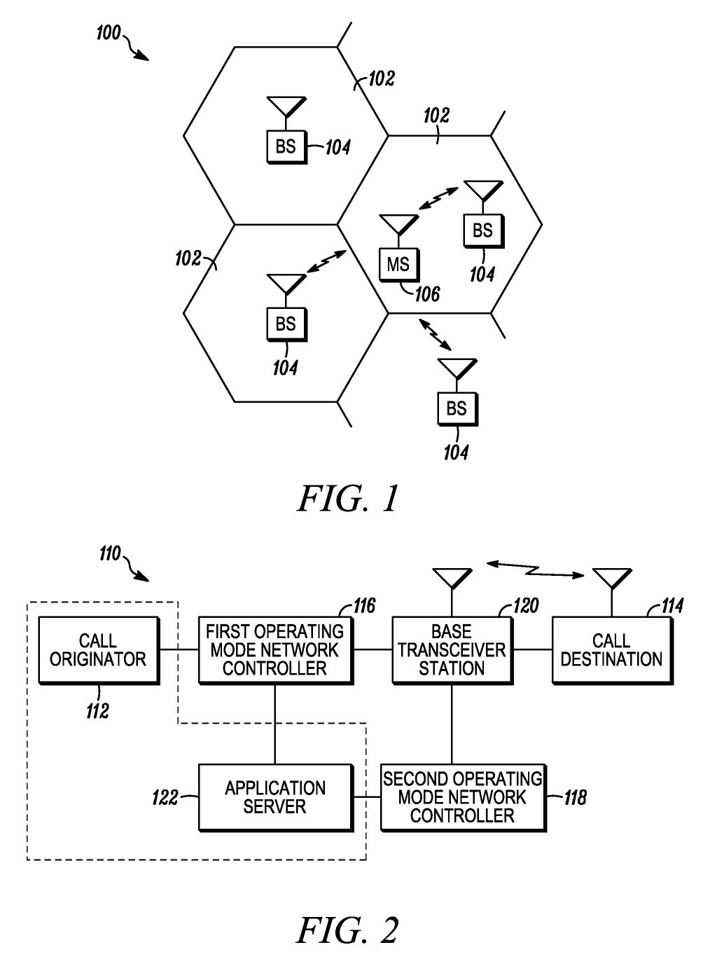

FIG. 1 illustrates an exemplary topographical view of portions of a wireless communication system. The topographical view 100 includes a plurality of cells 102 pictorially represented as hexagons. The hexagons are only rough approximations, where in reality the area of transmission for each of the cells 102 is not so uniformly defined. Each cell 102 is typically served by one or more base stations (BS) 104, referred to as a serving base station, which communicates with mobile stations (MS) 106 traveling within the corresponding cell 102, and/or within proximity of the corresponding base station 104. By spacing apart the base stations 104, in accordance with the cell pattern, theoretically a communication can be maintained as a mobile station 106 moves through the region and across cell 102 boundaries.

Generally, the further a mobile station 106 moves away from the serving base station 104 the weaker the signal gets. Conversely, as a mobile station 106 moves toward a base station 104 the signal typically becomes stronger. As a mobile station 106 continues to move away from a serving base station 104 and towards a base station 104 of a neighboring cell 102, at some point it may become desirable to transfer control of an existing communication connection to the base station 104 of the neighboring cell 102. In this way, a communication connection with mobile station 106 can be maintained as the mobile station moves relative to the various base stations 104, despite changing communication conditions.

In addition to supporting a communication connection with multiple base stations, at least some mobile stations have the ability to support the ability to communicate using multiple different operating modes, including a more traditional circuit switched communication mode, and a packet data communication mode. In circuit switching, there are commonly multiple individual circuits supported by a system, which are individually assigned to a particular user for the duration of a call, but are otherwise generally available to all users, where an individual making a call generally gets the full use of a particular circuit for the completion of a call with another user for the duration of a call. However, just like the communication circuit that is available for full use by a particular user for the duration of the call, the communication circuitry in the communication device, such as a radio transceiver that supports communication via a single communication circuit, is largely occupied supporting the communication via the particular established communication circuit, which makes the establishment of an additional communication connection difficult in absence of additional communication circuitry, such as a second transceiver. Traditionally, a large number of voice communication connections are established using circuit switched connections.

Alternatively packet switching, supports multiple simultaneous data flows, which share one or more particular communication pathways, where the simultaneous data flows are each organized in one or more bursts of data or packets, that occupy a shared communication pathway for a finite duration. The non-contiguous bursts of data are then routed to their destination, where they can be appropriately combined, to reconstruct the particular communications intended for the particular destination. Typically, the same network circuitry for a packet switching system, as well as a single communication connection to the network circuitry, can support one or more data flows for an individual user. The same network circuitry generally can often support one or more data flows for multiple users, as well. The ability to support multiple communications via a single communication connection allows additional communications to be concurrently routed to a particular call destination, even when other communications for another call are already being routed to the particular call destination.

An example of a still further type of switching includes message switching, which allows messages to be sent, but not immediately received, where the messages might be stored at a repository, for later retrieval by the intended recipient, which is commonly used for voice mail messaging systems.

Furthermore within a particular operating mode, multiple types of calls may be supported. For example, a circuit switched network might support voice communications, data communications (i.e. via a dial-up modem), and/or facsimile communications. A packet switched network might support voice communications (i.e. voice over IP, push-to-talk, etc.), and/or data communications (i.e. Internet web browsing, File Transfer Protocol, text messages, etc.).

In certain instances, use of a particular operating mode or call type may not be possible or may be inappropriate. For example, in the instance, where a circuit switched network connection is already being used it may not be possible to conveniently support a further simultaneous circuit switched network connection in order to support a further communication, or without unduly interfering with the already established connection. In other instances, the circumstances may result in the receipt of a particular type of call by a user as being viewed as socially inappropriate, such as a voice communication in a quiet environment, which generally does not allow one to talk into a microphone without disturbing other people in the user's vicinity. In accordance with at least one aspect of the present invention, a call is redirected from one operating mode to another operating mode, and the type of call is converted from one type to another type, so that it can more readily be received by the call destination, and accommodate instances in which the non-redirected and non-converted call could not be readily received.

FIG. 2 illustrates a block diagram of a communication system 110 in accordance with at least one embodiment of the present invention. The communication system 110 includes a plurality of communication devices including a call originator 112 and a call destination 114, where communication connections for supporting a call are made between an intended source and destination via a network infrastructure that facilitates communication between the various communication devices. In the illustrated embodiment, the network infrastructure includes a first operating mode network controller 116, which supports communications via the network using a first operating mode, a second operating mode network controller 118, which supports communications via the network using a second operating mode, and a base transceiver station 120. The base transceiver station 120 provides for the wireless communication connection with a potential call destination 114, and may similarly support a communication connection with a call originator 112, where the call originator 112 might communicate with the network infrastructure via a wireless communication connection.

The communication system 110 further includes an application server 122, which supports the redirection and the conversion of a call, in accordance with at least some embodiments of the present invention. In some instances, the application server 122 is included as part of the network infrastructure, where the redirection of a call and the corresponding conversion of the call data associated with a call can be performed largely independent of the call originator. In other instances, the features of the application server 122 are incorporated as part of the call originator 112, which allows the call originator to be more directly involved in any call redirection and any corresponding conversion of call data.

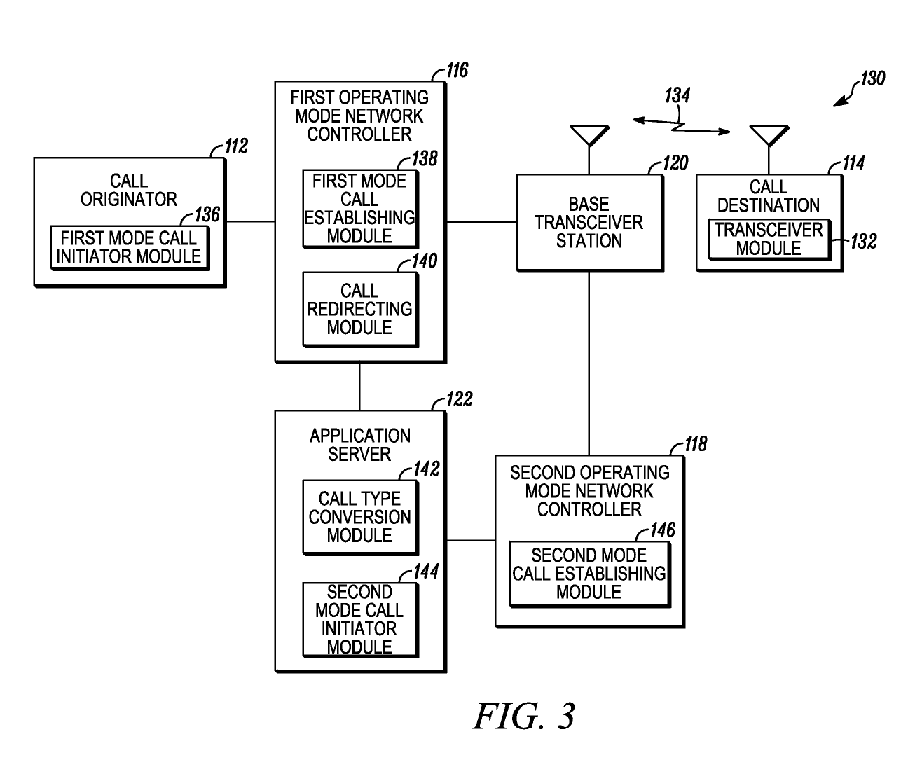

FIG. 3 illustrates a more detailed exemplary block diagram of the communication system 110 illustrated in FIG. 2, where the application server is included as part of the network infrastructure. Similar to FIG. 2, the more detailed block diagram of the communication system 130 includes a call originator 112 and a call destination 1 14. In the illustrated embodiment, the call destination 114 includes a transceiver module, which facilitates wireless communications 134 between at least the call destination 114 and the base transceiver station 120. The call originator 112 includes a first mode call initiator module 136, which allows the call originator 112 to initiate a communication with the call destination 114 via a first operating mode network. When the call originator 112 attempts to initiate a call via a first mode, a call initiation request is sent by the call originator 112 to the first operating mode network controller 116. The first operating mode network controller 116 includes a first mode call establishing module 138 which then attempts to establish a call.

In order to establish a call, the network will often require various signaling to occur between the call originator 112, the call destination 114, and the intermediary network elements in accordance with a corresponding protocol to establish and maintain a communication connection. During the process of establishing a call, some of the signaling will convey progress and/or status indications concerning the success or failures associated with the attempt. While in many instances a call can be successfully established, in some instances, it may not be possible to establish a call. Correspondingly, the protocol will generally provide an indication of an inability to connect, where the circumstances do not allow such a connection to be made.

Historically, when an attempt to establish a communication attempt has failed, some systems have provided the call originator with a signal indicative of the call destination's busy status. In other instances, some systems will connect the call originator 112 with a voice messaging system to enable the call originator 112 to record a message for later retrieval by the call destination 114. However, as noted above, the circumstance may make it desirable to pursue further connection possibilities.

In accordance with at least one aspect of the present invention, the first operating mode network controller 116 further includes a call redirecting module 140. The call redirecting module 140 upon receipt of an indication that the call cannot be established via the first mode routes control of the call to an application server 122. The application server includes a call type conversion module 142 and a second mode call initiator module 144. The call type conversion module 142 facilitates the conversion of the call data from call data consistent with the type of call used to attempt to establish a call via the first mode to call data consistent with a type of call to be used to attempt to establish a call via a second mode. In some instances, the call data can be converted between voice data and a textual representation of the voice data, and vice versa. However, conversions between other types of call data are similarly possible without departing from the teachings of the present invention. The second mode call initiator module 144 of the application server 122 then attempts to initiate a call via a second mode. More specifically, the application server 122 communicates with a second operating mode network controller, which includes a second mode call establishing module 146. The second mode call establishing module 146 attempts to establish a call using the second mode via base transceiver station 120. In some instances, when attempting to establish a call using the second mode, an established communication connection may already be available for use. In other instances, it may be necessary to establish a communication connection via the second mode.

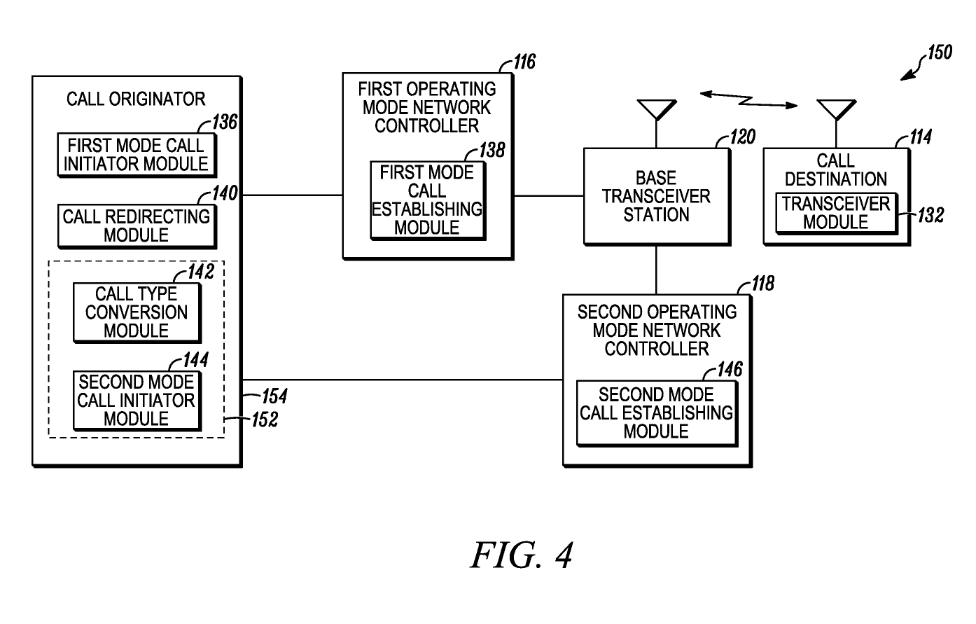

FIG. 4 illustrates a more detailed exemplary block diagram of a communication system 150, in accordance with at least a further embodiment of the present invention. The communication system 150 illustrated in FIG. 4 is similar to the communication system 130 illustrated in FIG. 3 with the exception that the features 152 associated with the application server 122, namely the call type conversion module 142 and the second mode call initiator module 144 are alternatively incorporated as part of the call originator 154. Additionally, the call redirecting module, identified as being associated with the first operating mode network controller 116 in connection with the embodiment illustrated in FIG. 3, can be alternatively incorporated as part of the call originator 154.

When included as part of the network (FIG. 3), the application server 122 can serve as a bridge between the first operating mode network and the second operating mode network. The conversion and redirection can generally be transparent to the call originator 112, where the call originator 112 can continue to interact with the network in a manner, which is consistent with the first operating mode. In this instance, the network detects an inability to communicate with the call destination 114, as originally requested by the call originator 112, and identifies an alternative mode for establishing the requested connection.

In some instances, the call destination 114 may identify an alternative manner of call completion (i.e. a redirection request) as part of the call rejection associated with the attempt to complete the call via the first operating mode. The identified alternative manner may be pre-established based upon a pre-stored indication of user preferences, or the identified alternative manner can be more interactively selected by the call destination user at the time an attempt to establish a call via the first operating mode was made. In other instances, the network may maintain a record of call destination device capabilities and may seek to automatically suggest an alternative connection mode. In some of these instances, the process may alert the call originator user of an intent to attempt a connection via an alternative (i.e. second) operating mode, and sometimes may seek an authorizing confirmation from the call originator user before attempting to convert and redirect the call via the second operating mode.

When the call conversion and redirection occurs within the network, the network can continue to interact with the call originator 112 via the first operating mode, and therefore may allow a connection with the call destination 114 via the alternative (i.e. second) operating mode even though the call originator 112 may not natively support such a mode, and/or may prefer to continue to interact with the call destination 114 in a manner consistent with the first operating mode.

When the application server functionality as well as the call redirection functionality is included in the call originator 154, the call originator 154 can facilitate a call connection via an alternative second mode upon failure of the first mode independent of support and/or changes in the network infrastructure. However, in such an instance, it would be beneficial for the call originator 154 to be able to directly support an ability to communicate in at least each of the two operating modes.

In FIGS. 3 and 4 various modules have been illustrated, which form parts of the various identified elements. In some instances, the modules may represent at least partially one or more sets of prestored instructions, which can be executed by a controller, such as a microprocessor. In other instances the modules may be implemented at least partially using sequential state machines implemented in hardware using logic gates or using prestored programming constructs. One skilled in the art will recognize that various constructs can be used to implement the various modules without departing from the teachings of the present invention.

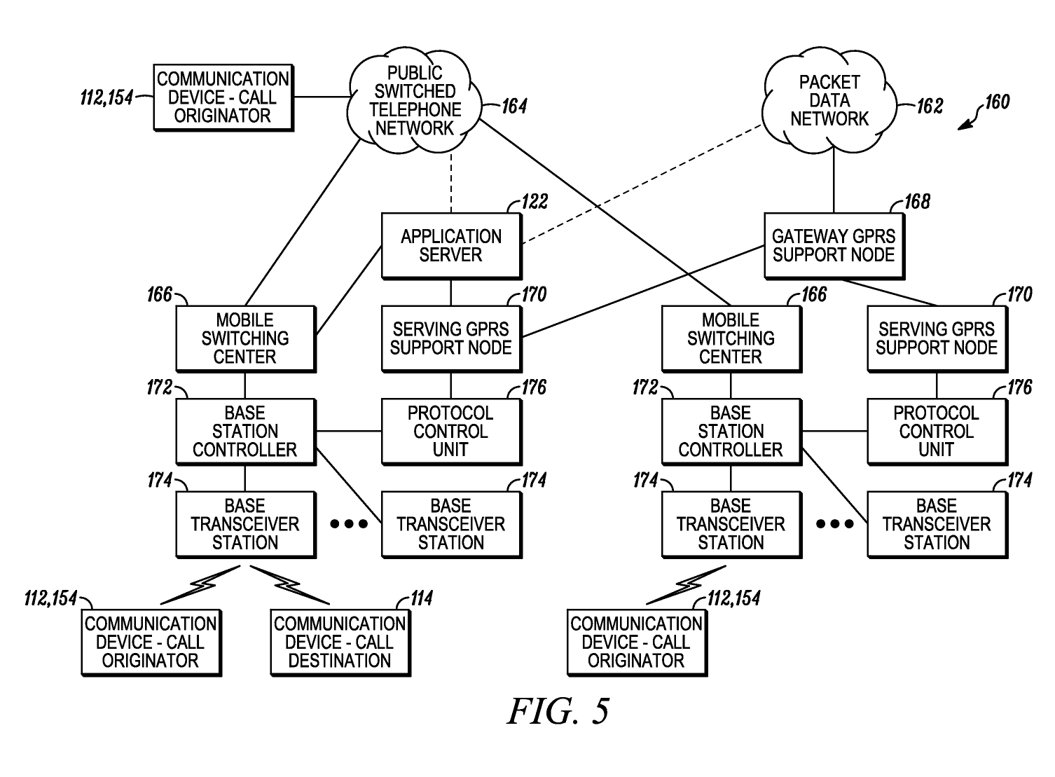

FIG. 5 illustrates a block diagram 160 illustrating a pair of exemplary networks, namely a packet data network 162 and a circuit switched network 164 (i.e. a public switched telephone network), in which at least one embodiment of the present invention is intended to operate. Many of the network elements are consistent with the global system for mobile communications (GSM) standard, and facilitate the communication of data via a wireless communication network to the public switched telephone network 164 and a packet data network 162, such as the Internet. The public switched telephone network is coupled to one or more base station subsystems, via one or more mobile switching centers 166, where the base station subsystem will often include a base station controller 172 and one or more base transceiver stations 174. The packet data network 162 is coupled to the base station subsystem via one or more gateway GPRS support nodes 168 and one or more serving GPRS support nodes 170. In some instances multiple base station subsystems will share the same mobile switching centers 166, serving GPRS support nodes 170, and/or gateway GPRS support nodes 168.

A base station controller 172 couples one or more base transceiver stations 174 (i.e. base stations 104), which incorporate one or more transceivers as part of a wireless interface, to the mobile switching center 166 for facilitating the transfer of circuit switched data to the public switched telephone network 164. The base station controller 172 further couples the one or more corresponding base transceiver stations 174 to the serving GPRS support node 170, via a protocol control unit 176 for facilitating the transfer of packet data received from a communication device call originator 112 or 154 and/or a communication device call destination 114 (i.e. mobile subscriber 106) to the packet data network 162.

In accordance with at least some embodiments of the present invention, a mobile switching center 166 could serve as a network controller for a circuit switched network (i.e. public switched telephone network 164), and a serving GPRS support node 170 could serve as a network controller for a packet data network 162. In the illustrated embodiment, an application server 122 is further illustrated, which is coupled to both the mobile switching center 166 and the serving GPRS support node 170. Additionally and/or alternatively, the application server 122 can be coupled to other network elements operating as a network controller via the two or more respective networks 162, 164.

In at least some instances, the communication device, which is acting as the call originator 112, 154 could have a wired connection to the public switched telephone network, such as a traditional land line telephone. The call originator 112, 154 could alternatively be a wireless communication device, such as a cellular radio telephone, which is coupled to one or both of the networks via a base transceiver station 174. The call originator 112, 154, in some instances could be coupled to the network via the same base station transceiver station 174, or a base transceiver station 174 commonly controlled by the same base station controller 172 or mobile switching center 166. In other instances, the call originator 112, 154, could be coupled to the network via a separate communication branch including a separate base transceiver station 174, base station controller 172 and mobile switching center 166.

An application server 122, included as part of the network, in the same branch as the call destination 114 can often facilitate the rerouting and the conversion of call data while maintaining a bulk of the control signaling in the branch associated with the call destination 114, even when the call originator is not coupled to the network via the same communication branch. However, when the application server and call redirecting functionality is incorporated as part of the call originator 154, the control of the call and the corresponding call signaling in at least some instances may need to trace all the way back to the call originator 154 in order for the call data to be converted and the call redirected.

While the embodiment illustrated in connection with FIG. 5 makes use of exemplary structures consistent with the type of circuit switched network 164 and packet data network 162 corresponding to a cellular wireless communication network in accordance with the GSM standard, one skilled in the art will readily appreciate that the teachings of the present application are similarly applicable to other network standards, as well as other network types.

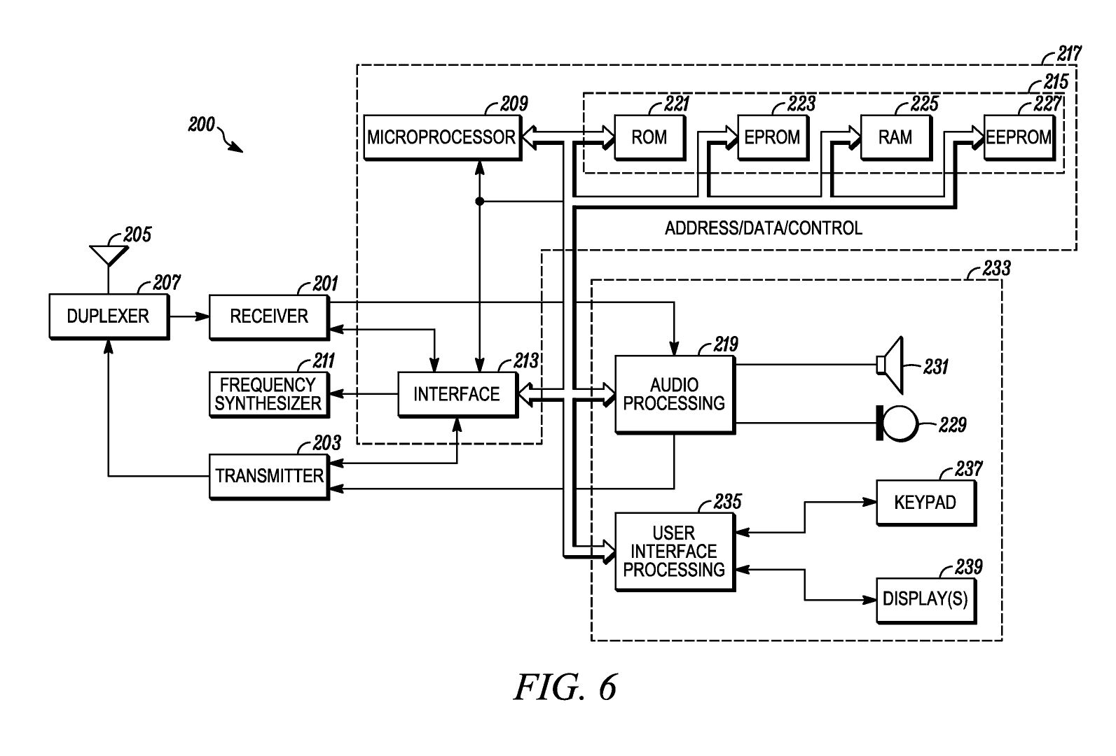

FIG. 6 illustrates an exemplary block diagram of least one embodiment of the wireless communication device 200, which could be used to implement the present invention. The wireless communication device 200 includes a radio receiver 201 and a transmitter 203, which in some instances may be implemented together as a radio transceiver. Both the receiver 201 and the transmitter 203 are coupled to an antenna 205 of the wireless communication device by way of a duplexer 207. The particular radio frequency to be used by the transmitter 203 and the receiver 201 is determined by the microprocessor 209 and conveyed to the frequency synthesizer 211 via the interface circuitry 213. Data signals received by the receiver 201 are decoded and coupled to the microprocessor 209 by the interface circuitry 213, and data signals to be transmitted by the transmitter 203 are generated by the microprocessor 209 and formatted by the interface circuitry 213 before being transmitted by the transmitter 203. Operational status of the transmitter 203 and the receiver 201 is enabled or disabled by the interface circuitry 213.

In the preferred embodiment, the microprocessor 209 forms part of the processing unit, which in conjunction with the interface circuitry 213, performs the necessary processing functions under the control of prestored sets of program instructions stored in a memory section 215. Together, the microprocessor 209 and the interface circuitry 213 can include one or more microprocessors, one or more of which may include a digital signal processor (DSP). The memory section 215 includes one or more forms of volatile and/or non-volatile memory including conventional ROM 221, EPROM 223, RAM 225, or EEPROM 227. Identifying features of the wireless communication device are typically stored in EEPROM 227 (which may also be stored in the microprocessor in an on-board EEPROM, if available) and can include the number assignment (NAM) required for operation in a conventional cellular system.

To the extent that the one or more identified modules are implemented in hardware, either in whole or in part, the logic elements could be located in interface 213 and or make use of memory elements in memory section 215. To the extent that the one or more modules are implemented using programming instructions, the programming instruction could be stored in memory section 215 for execution by one or more processors including microprocessor 209.

Control of user audio, the microphone 229 and the speaker 231, is controlled by audio processing circuitry 219, which forms part of a user interface circuit 233. The user interface circuit 233 additionally includes user interface processing circuitry 235, which manages the operation of any keypad(s) 237 and/or display(s) 239. It is further envisioned that any keypad operation could be included as part of a touch sensitive display.

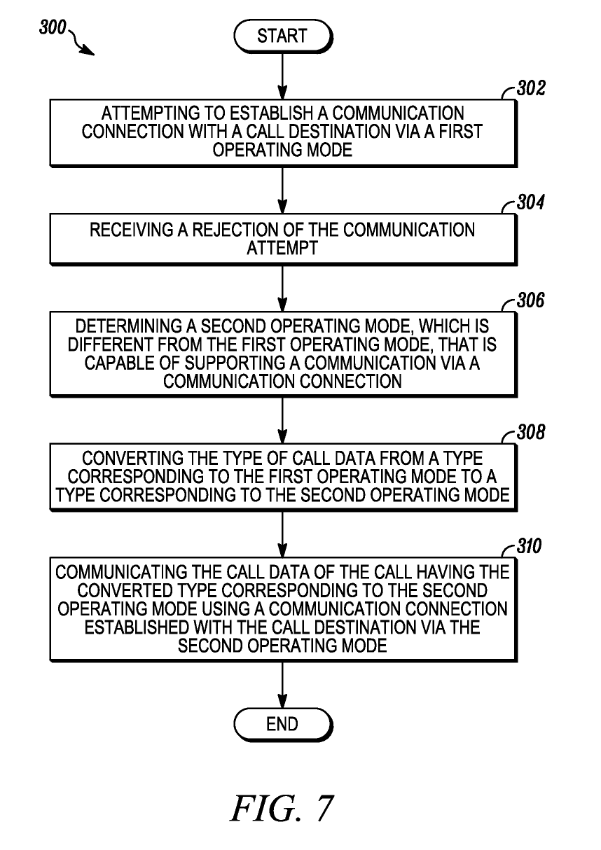

FIG. 7 illustrates a flow diagram 300 of a method for redirecting a call to a call destination between multiple different operating modes, in accordance with at least one embodiment of the present invention. The method includes attempting to establish a communication connection with a call destination via a first operating mode 302. If a rejection of the communication attempt is received 304, a second operating mode is determined 306, which is different from the first operating mode, and is capable of supporting a communication via a communication connection. The call data is then converted 308 from a type corresponding to a first operating mode to a type corresponding to a second operating mode. The converted call data of the type corresponding to the second operating mode is then communicated 310 to the call destination using a communication connection established via the second operating mode.

In at least one embodiment converting a type of the call data includes converting speech data to text data.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for redirecting a call to a call destination between multiple different operating modes, the method comprising:
attempting to establish a communication connection with the call destination via a first operating mode;
receiving a rejection of the attempt to establish a communication connection;
determining a second operating mode, which is different from the first operating mode, that currently is capable of supporting a communication with the call destination via a communication connection;
converting a type of call data for the call from a type corresponding to the first operating mode to a type corresponding to the second operating mode; and
communicating the call data of the call having the converted type corresponding to the second operating mode using a communication connection established with the call destination via the second operating mode.

2. A method in accordance with claim 1, wherein the first operating mode is a circuit switched communication mode.

3. A method in accordance with claim 1, wherein the second operating mode is a packet data communication mode.

4. A method in accordance with claim 3, wherein the communication connection established with the call destination via the packet data communication mode includes a text messaging call session.

5. A method in accordance with claim 4, wherein converting a type of the call data includes converting speech data to text data.

6. A method in accordance with claim 3, wherein the communication connection established with the call destination via the packet data communication mode includes a push to talk call session.

7. A method in accordance with claim 3, wherein the communication connection established with the call destination via the packet data communication mode includes a voice over internet protocol call session.

8. A method in accordance with claim 1, wherein the received rejection includes a redirection request.

9. A method in accordance with claim 8, wherein the redirection request includes an identification of the suggested second operating mode and a particular type corresponding to the second operating mode from one or more possible types.

10. A method in accordance with claim 8, wherein the redirection request causes the call to be routed to an application server, that forms at least part of a network infrastructure, where the application server manages the alternative routing of the call via the second operating mode.

11. A method in accordance with claim 1, wherein communicating the call data of the call having the converted type corresponding to the second operating mode includes using a pre-existing communication connection established with the call destination via the second operating mode.

12. A method in accordance with claim 1, wherein communicating the call data of the call having the converted type corresponding to the second operating mode includes establishing a communication connection with the call destination via the second operating mode.

13. A method in accordance with claim 1, wherein attempting to establish a communication with the call destination via a first operating mode includes providing an alert of an incoming call to a user of a device serving as the call destination.

14. A method in accordance with claim 1, wherein attempting to establish a communication with the call destination via a first operating mode includes checking a current call forwarding status of the call destination.

15. A method in accordance with claim 1, wherein the communication connection established with the call destination via the second operating mode occurs between a network infrastructure and the call destination, and wherein the call type conversion occurs in the network infrastructure.

16. A method in accordance with claim 1, wherein the communication connection established with the call destination via the second operating mode occurs between a call originator and the call destination, and wherein the call type conversion occurs in the call originator.

17. A method in accordance with claim 1, wherein the call destination is a mobile subscriber.

18. A method in accordance with claim 17, wherein the mobile subscriber is a radio telephone.

19. A communication system comprising:
a plurality of communication devices including a call originator and a call destination, where at least the call destination includes a transceiver module for selectively establishing a communication connection via a first operating mode and a second operating mode;
a base transceiver station, which is adapted to selectively communicate with one or more of the plurality of communication devices via a first operating mode and a second operating mode,
a first operating mode network controller coupled to the base transceiver station, the first operating mode network controller including
a first mode call establishing module for establishing a communication connection for a call from the call originator to the call destination via the first operating mode, and
a call redirecting module for redirecting the call upon receipt of a rejection of an attempt to establish a communication connection via the first operating mode;
a second operating mode network controller coupled to the base transceiver station, the second operating mode network controller including a second mode call establishing module for establishing a communication connection with the call destination via the second operating mode; and
an application server coupled to the first operating mode network controller and the second operating mode network controller, the application server including
a call type conversion module for converting the type of a call redirected to the application server for communication via the second operating mode, and
a second mode call initiating module for initiating a communication connection with the call destination via the second operating mode.

20. A communication system comprising:
a plurality of communication devices including a call originator and a call destination, where at least the call destination includes a transceiver module for selectively establishing a communication connection via a first operating mode and a second operating mode;
a base transceiver station, which is adapted to selectively communicate with one or more of the plurality of communication devices via a first operating mode and a second operating mode;
a first operating mode network controller coupled to the base transceiver station, the first operating mode network controller including a first mode call establishing module for establishing a communication connection for a call from the call originator to the call destination via the first operating mode and providing feedback regarding whether the communication connection could be successfully established; and
a second operating mode network controller coupled to the base transceiver station, the second operating mode network controller including a second mode call establishing module for establishing a communication connection for a call from the call originator to the call destination via the second operating mode; and
wherein the call originator includes
a first mode call initiator module for initiating a communication connection for a call from the call originator to the call destination via the first operating mode,
a call redirecting module for redirecting the call via a second operating mode upon receipt of a rejection of an attempt to establish a communication connection via the first operating mode,
a call type conversion module for converting the type of a call which could not be established via the first operating mode from a first operating mode type to a second operating mode type, and
a second mode call initiator module for initiating a communication connection for a call from the call originator to the call destination via the second operating mode.
